(19) United States
(12) Patent Application Publication
(10) Pub. No.: US 2015/0199337 A1
(43) Pub. Date: Jul. 16, 2015

(54) SMART DEVICE CAPABLE OF EASILY CONVERTING INTO MULTINATIONAL LANGUAGES

(71) Applicants: Hyoseok Park, Busan (KR); ASIA COMMUNICATION., LTD., Busan (KR)

(72) Inventors: Hyoseok Park, Busan (KR); Jaehong Lee, Busan (KR)

(21) Appl. No.: 14/127,328

(22) PCT Filed: Aug. 28, 2013
(86) PCT No.: PCT/KR2013/007559

§ 371 Date: Dec. 18, 2013

(30) Foreign Application Priority Data
Aug. 7, 2013 (KR) 10-2013-0093424

(51) Int. Cl. G06F 17/28

(52) U.S. Cl. CPC G06F 17/289

(57) ABSTRACT

The invention relates to a smart device capable of easily converting into multinational languages in that it connects to a website for providing multinational language information (contents) by using the smart device; transmits unique key value information of particular original information (contents) and unique key value information of specific language to a multinational language conversion management server when it clicks the particular original information (contents) and the desiring specific language, providing the contents information converted into the specific language; transmits unique key value of specific language to the multinational language conversion management server when it selects the specific language from a multinational language selector button arranged on a keyboard of the smart device; and relocates the keyboard button provided from the multinational language conversion management server, thereby rapidly and easily processing the multinational language conversion.

### TECHNICAL FIELD

The invention relates to a smart device capable of easily converting into multinational languages, and more particularly, to a smart device capable of easily converting into multinational languages in that it connects to a website for providing multinational language information (contents) by using the smart device; transmits unique key value information of particular original information (contents) and unique key value information of specific language to a multinational language conversion management server when it clicks the particular original information (contents) and the desiring specific language; providing the contents information converted into the specific language; transmits unique key value of specific language to the multinational language conversion management server when it selects the specific language from a multinational language selector button arranged on a keyboard of the smart device; and relocates the keyboard button provided from the multinational language conversion management server, thereby rapidly and easily processing the multinational language conversion.

### BACKGROUND ART

Until now, each of the multi-language websites is separately produced for each language. Also, in the using method thereof, if the desiring language is selected, it moves to the selected homepage.

In this way, if the using languages are increased, it must separately maintain each website every languages. Also, the contents should be managed separately. Accordingly, it is forced to provide a limited language translation service.

For example, if one content is created, it is individually uploaded to each website having other languages. Also, where this content is modified, it should be modified in each website having other languages.

This is a common problem in that not only the contents but also the code, images, and videos commonly used and existed in the website should be individually managed. Accordingly, in order to produce the website capable of dealing with the world's languages at once, the corresponding websites of constituting the web server, the codes, the images and the videos etc. should be existed up to the number of the world's languages, thereby astronomically increasing the production cost and the maintenance cost.

On the other hand, with the development of the internet and the information and communication, the smart phones or the smart TV etc. are becoming common.

At this time, in case of the smart phone, where various information are sent and received in a particular language, it is necessary to provide keyboard layouts of the corresponding language. Also, in order to input the desiring word to the keyboard of the specific language, since it goes through a separate operation, there is an inconvenience in use.

On the other hand, in case of a translator used in the smart phone, it goes through a total of eight stages such as User application exit->Translator application execution->Text input->Translation->Selection and copy->Translator application exit->User application execution->Paste. However, Accordingly, since the translation using the smart phone goes through the total of at least eight stages, there is a considerable inconvenience in use.

### DISCLOSURE

### Technical Problem

Accordingly, the present invention has been made to solve the above-mentioned problems occurring in the prior art, and a first object of the present invention is to provide a smart device capable of easily converting into multinational languages in that it connects to a website for providing multinational language information (contents) by using a user terminal; transmits unique key value information of particular original information (contents) and unique key value information of specific language to a multinational language conversion management server when it clicks the particular original information (contents) and the desiring specific language; providing the contents information converted into the specific language; transmits unique key value of specific language to the multinational language conversion management server when it selects the specific language from a multinational language selector button arranged on a keyboard of the smart device; and relocates the keyboard button provided from the multinational language conversion management server, thereby rapidly and easily processing the multinational language conversion.

A second object of the present invention is to provide a smart device capable of easily converting into multinational languages in that it provides a machine-translated text information to the corresponding user terminal by performing the machine translation thereof when the translation text information of the particular language is not existed therein.

A third object of the present invention is to provide a smart device capable of easily converting into multinational languages in that, when the user does not know the language on a quest of the websites in the smart device, the text of the corresponding language is pressed long, so that the translation button and the pop-up such as copy, paste, and delete etc., are displayed thereon; when the translate button is clicked, a small window capable of selecting the languages is opened; and when the desiring language is selected, the original text of the corresponding website is replaced with the translated text.

### Technical Solution

In order to accomplish this object, there is provided a smart device capable of easily converting into multinational languages comprising: a smart device 100 for connecting to a website for providing multinational language information (contents), transmitting unique key value information of particular original information (contents) and unique key value information of specific language to a multinational language conversion management server when it clicks the particular original information (contents) and the desiring specific language, transmitting unique key value of specific language to the multinational language conversion management server when it selects the specific language from a multinational language selector button arranged on an upper end of a keyboard, and relocating the keyboard button provided from the multinational language conversion management server; and the multinational language conversion management server 200 comprising an original information DB 205 for storing at least one information among a text information, an image information, a video information, and an audio information of the original (contents) and storing the unique key value information of the original (contents); a translation information DB 210 for storing a translation text information by language of matching with the unique key value information of the original (contents); an unique key value information DB by information 215 for storing and managing the unique key value information of the original (contents) and an unique key value information by language; a text DB 220 for matching the original text and the translation text information with the unique key value information of the original (contents) and the unique key value information by language to be stored; a multimedia information DB 225 for storing at least one information among the image information, the video information, and the audio information attached to the information (contents) of matching with the unique key value information of the original; a category information DB 230 for storing the unique key value information of the original (contents) and the unique key value information by language stored in the unique key value information DB by information and routing values of the DBs; a click information and language obtaining unit 235 for obtaining the unique key value information of the original (contents) and the unique key value information of the particular language clicked in the smart device; a particular language translation information extraction unit 240 for extracting a translation text information of the corresponding particular language from the text DB with reference to the unique key value information of the original (contents) and the unique key value information of the particular language obtained by the click information and language obtaining unit; and a particular language translation information text conversion unit 245 for converting the original text into the translation text information of the corresponding particular language extracted by the particular language translation information extraction unit.

### Advantageous Effects

According to the smart device capable of easily converting into multinational languages, there is an effect in that it connects to a website for providing the multinational language information (contents) by using the user terminal; transmits the unique key value information of the particular original information (contents) and the unique key value information of specific language to the multinational language conversion management server when it clicks the particular original information (contents) and the desiring specific language; providing the contents information converted into the specific language; transmits the unique key value of the specific language to the multinational language conversion management server when it selects the specific language from the multinational language selector button arranged on the keyboard of the smart device; and relocates the keyboard button provided from the multinational language conversion management server, thereby rapidly and easily processing the multinational language conversion.

There is another effect in that, when the translation text information of the particular language is not existed therein, it provides the machine-translated text information to the corresponding user terminal by performing the machine translation thereof, thereby easily grasping the contents thereof.

There is further another effect in that, when the user does not know the language on a quest of the websites in the smart device, the text of the corresponding language is pressed long, so that the translation button and the pop-up such as copy, paste, and delete etc., are displayed thereon; when the translate button is clicked, the small window capable of selecting the languages is opened; and when the desiring language is selected, the original text of the corresponding website is replaced with the translated text without the moving of the webpage.

Also, when the user is accessed through the smart device, it extracts the member region information and the using language information with reference to the IP address information and the keyboard of the corresponding language is primarily arranged, thereby improving convenience in use.

Moreover, the buttons and the images are minimized, thereby rapidly checking out the information (contents) in the countries and the regions with poor internet environment; and, in the change of the language, since the page loaded once can be utilized as it is without changing the language through the movement of the webpage, only the text portions of the information (contents) is transmitted in real time so as to change the language, so that it is not necessary to reload the unnecessary HTML tags and the common parts of the web site (the images and videos, etc. such as the top menu, the advertisement, the bottom menu, and the information (contents)), thereby minimizing the traffic.

### BRIEF DESCRIPTION OF THE DRAWINGS

The above and other objects, features and advantages of the present invention will be more apparent from the following detailed description taken in conjunction with the accompanying drawings, in which:

FIG. 1 is an entire block diagram illustrating a smart device capable of easily converting into multinational languages according to the present invention;

FIG. 2 is a block diagram illustrating a multinational language conversion management server of a smart device capable of easily converting into multinational languages according to the present invention;

FIG. 3 is a block diagram illustrating a multinational language keyboard conversion means of a smart device capable of easily converting into multinational languages according to the present invention;

FIG. 4 is a block diagram illustrating a multinational language keyboard translation means of a smart device capable of easily converting into multinational languages according to the present invention;

FIG. 5 is a block diagram illustrating a long press translation means of a smart device capable of easily converting into multinational languages according to the present invention; and

FIG. 6 through FIG. 8 are example views illustrating a multinational language selector opening/closing button and a multinational language selector button of a smart device capable of easily converting into multinational languages according to the present invention.

### BEST MODE

### Mode for Invention

There is provided a smart device capable of easily converting into multinational languages includes a smart device 100 for connecting to a website for providing multinational language information (contents), transmitting unique key value information of particular original information (contents) and unique key value information of specific language to a multinational language conversion management server when it clicks the particular original information (contents) and the desiring specific language, transmitting unique key value of specific language to the multinational language conversion management server when it selects the specific language from a multinational language selector button arranged on an upper end of a keyboard, and relocating the keyboard button provided from the multinational language conversion management server; and the multinational language conversion management server 200.

The multinational language conversion management server 200 includes an original information DB 205 for storing at least one information among a text information, an image information, a video information, and an audio information of the original (contents) and storing the unique key value information of the original (contents);

a translation information DB 210 for storing a translation text information by language of matching with the unique key value information of the original (contents);

an unique key value information DB by information 215 for storing and managing the unique key value information of the original (contents) and an unique key value information by language;

a text DB 220 for matching the original text and the translation text information with the unique key value information of the original (contents) and the unique key value information by language to be stored;

a multimedia information DB 225 for storing at least one information among the image information, the video information, and the audio information attached to the information (contents) of matching with the unique key value information of the original;

a category information DB 230 for storing the unique key value information of the original (contents) and the unique key value information by language stored in the unique key value information DB by information and routing values of the DBs;

a click information and language obtaining unit 235 for obtaining the unique key value information of the original (contents) and the unique key value information of the particular language clicked in the smart device;

a particular language translation information extraction unit 240 for extracting a translation text information of the corresponding particular language from the text DB with reference to the unique key value information of the original (contents) and the unique key value information of the particular language obtained by the click information and language obtaining unit; and

a particular language translation information text conversion unit 245 for converting the original text into the translation text information of the corresponding particular language extracted by the particular language translation information extraction unit.

Hereinafter, an exemplary embodiment of the present invention will be described in detail with reference to the accompanying drawings.

The present invention may be embodied in many different forms without departing from the spirit and significant characteristics of the invention. Therefore, the embodiments of the present invention are disclosed only for illustrative purposes and should not be construed as limiting the present invention.

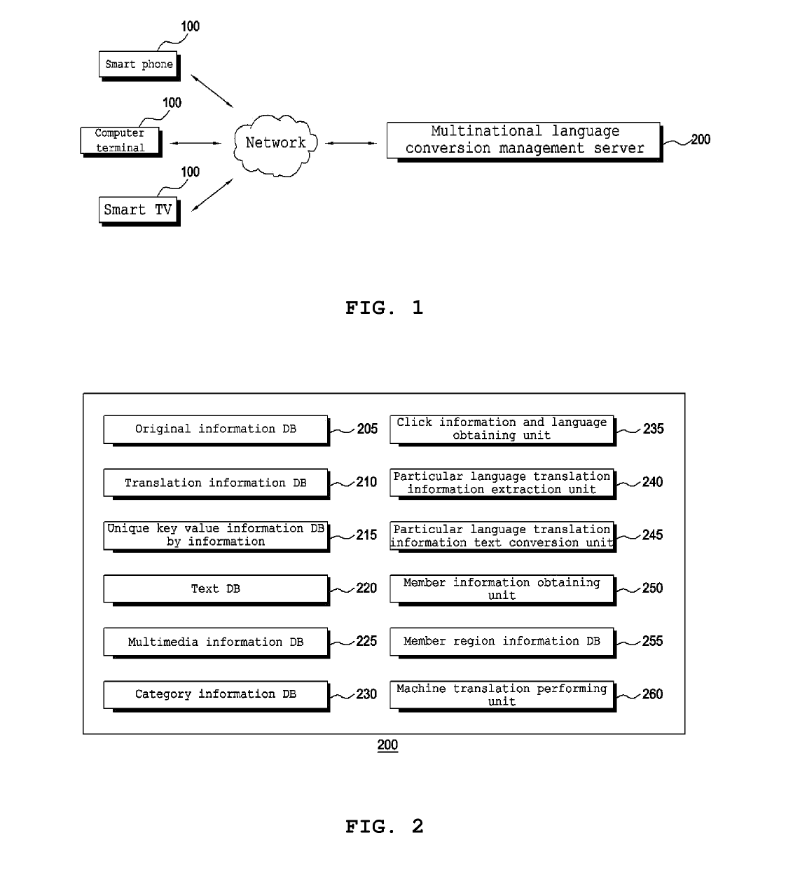

FIG. 1 is an entire block diagram illustrating a smart device capable of easily converting into multinational languages according to the present invention.

As shown in FIG. 1, the smart device 100 capable of easily converting into multinational languages according to the present invention serves to connect to a website for providing multinational language information (contents), transmit unique key value information of particular original information (contents) and unique key value information of specific language to a multinational language conversion management server when it clicks the particular original information (contents) and the desiring specific language, transmit unique key value of specific language to the multinational language conversion management server when it selects the specific language from a multinational language selector button arranged on an upper end of a keyboard, and relocate the keyboard button provided from the multinational language conversion management server.

At this time, the smart device may be a smart phone, a computer terminal, or a smart TV. Accordingly, it can be connected to the websites of providing services therethrough.

In case of the smart device, it downloads the apps to be activated, thereby executing the language conversion through the corresponding app.

The app is downloaded through the app store connected by the smart device to be loaded. Since the technology is well known, further description on this is omitted here.

At this time, the multinational language conversion management server 200 serves to change the corresponding contents into the specific language selected by a user in real time without the moving of the webpage, when the user clicks the desiring specific language button of the contents, thereby rapidly and easily providing the desiring information (contents) to the user.

That is, the selection button capable of selecting the specific language is provided on the screen. Accordingly, when the user clicks the specific language of the particular original information (contents), the unique key value information of the particular original information (contents) and the unique key value information of the specific language are transmitted to the multinational language conversion management server.

It searches the corresponding information (contents) with reference to the unique key value information.

So far, the multilingual sites are separately produced for each language. Thus, when it selects the desiring language, it moves to the selected homepage.

In this way, where the using languages are increased, it must maintain separate sites. Also, the contents should be managed separately.

For example, if one content is created, it is individually uploaded to each language site. Also, when the content is modified, it should be individually modified in each language site.

This is a common problem in that not only the contents but also the code, images, and videos commonly used and existed in the website should be individually managed. Accordingly, in order to produce the website capable of dealing with the world's languages at once, the corresponding websites of constituting the web server, the codes, the images and the videos etc. should be existed up to the number of the world's languages.

In the present invention, the user clicks the icon capable of representing the corresponding language arranged with the desiring contents on the screen of the webpage or the smart device by using an AJAX technology of a Java scrip and a HTML5, which are can be utilized in a single site or a single web-based device (smart devices such as smart phones or smart TV and other), so that only the text is received from the multinational language conversion management server and the network, thereby removing the text of the existed language and replacing it with the text of the language selected by the user.

More concretely, when the users utilizes the search or the contents in the web site or various smart devices, the language of the entire site is not changed during the language conversion. That is, if the user clicks or selects the language icon included with the desiring contents, the multinational language conversion management server serves to remove the existed text data of the corresponding contents area and the user receives only the selected language text from the multinational language conversion management server by means of the AJAX technology of the Java scrip and the HTML5 to be displayed on the corresponding area.

This approach can remarkably decrease the traffic in comparison with the existed methods. Also, it can be rapidly used in a poor Internet environment.

Also, in the present invention, during the initial loading in the website or the other smart device, it judges the access area and the main language of the user, so that the language is automatically converted into the corresponding language to be transmitted. Continuously, the representing language icons included with each contents are firstly arranged with the language icon of the access area and the main language icon of the user, so that the user can rapidly and easily use it and it reduces the traffic.

Eventually, since it is not moved to the separate language website unlike the existed multilingual website, it can stick to the position of the current webpage. Also, since only the text data is received to be changed, the images, the video or the code etc are not reloaded, thereby remarkably reducing the traffic. Moreover, since only the minimum data is received, the language conversion is faster than the existed manner. Furthermore, the contents can be rapidly used in a poor Internet environment.

On the other hand, in various smart devices such as the desktop, the smart phone, the smart TV etc., the web-based technologies have been increasingly developed.

In addition, the representing technologies such as XML or JSON etc. are utilized in the data transmittance method. The multilingual processing data can be transmitted through the technologies.

By using the data interchange method such as XML or JSON, it is possible to utilize the multilingual processing data in various smart devices.

FIG. 2 is a block diagram illustrating a multinational language conversion management server of a smart device capable of easily converting into multinational languages according to the present invention.

As described in FIG. 2, the multinational language conversion management server 200 includes an original information DB 205 for storing at least one information among a text information, an image information, a video information, and an audio information of the original (contents) and storing the unique key value information of the original (contents); a translation information DB 210 for storing a translation text information by language of matching with the unique key value information of the original (contents); an unique key value information DB by information 215 for storing and managing the unique key value information of the original (contents) and an unique key value information by language; a text DB 220 for matching the original text and the translation text information with the unique key value information of the original (contents) and the unique key value information by language to be stored; a multimedia information DB 225 for storing at least one information among the image information, the video information, and the audio information attached to the information (contents) of matching with the unique key value information of the original; a category information DB 230 for storing the unique key value information of the original (contents) and the unique key value information by language stored in the unique key value information DB by information and routing values of the DBs; a click information and language obtaining unit 235 for obtaining the unique key value information of the original (contents) and the unique key value information of the particular language clicked in the smart device; a particular language translation information extraction unit 240 for extracting a translation text information of the corresponding particular language from the text DB with reference to the unique key value information of the original (contents) and the unique key value information of the particular language obtained by the click information and language obtaining unit; and a particular language translation information text conversion unit 245 for converting the original text into the translation text information of the corresponding particular language extracted by the particular language translation information extraction unit.

At this time, the present invention is characterized in that the DBs are independently provided with the original information DB 205, the translation information DB 210, the unique key value information DB by information 215, the text DB 220, the multimedia information DB 225, and the category information DB 230 and so on to be distributed.

That is, the DB is distributed, so that large amounts of information can be sent and received in real time in the world.

The original information DB 205 serves to store at least one information among the text information, the image information, the video information, and the audio information of the original (contents) and store the unique key value information of the original (contents).

For example, if only the text information and video information are existed therein, the original information DB 205 serves to store and manage the text information and the video information.

Also, the original information DB 205 serves to store and manage the unique key value information of the original (contents).

The translation information DB 210 serves to store and manage the translation text information by language of matching with the unique key value information of the original (contents).

For example, if the unique key value information of the original (contents) is ‘123’, the corresponding unique key value information is stored in the translation information DB.

Also, the unique key value information DB by information 215 serves to store and manage the unique key value information of the original (contents) and the unique key value information by language.

That is, the unique key value information DB by information 215 stores the unique key value information of the original which is an identifier. Simultaneously, it severs to store and mange the unique key value information by language.

In the meantime, the information (contents) described in the present invention includes the contents described in a news or a portal site and the contents described in a community site. The technology of providing the multi-lingual information in one site belongs to the scope of the present invention.

The user provides the corresponding contents by means of the smart device.

The text DB 220 serves to match the original text (contents) and the translation text information with the unique key value information of the original (contents) and the unique key value information by language to be stored.

In other words, the multimedia information such as the image information, the video information, and the audio information is retained and only the texts by the corresponding language are stored and managed in the text DB.

Also, the multimedia information DB 225 serves to store at least one information among the image information, the video information, and the audio information attached to the information (contents) of matching with the unique key value information of the original.

As described above, the text information and the multimedia information can be independently operated, thereby minimizing the network traffic.

The category information DB 230 serves to store the unique key value information of the original (contents) and the unique key value information by language stored in the unique key value information DB by information and the routing values of the DBs.

That is, the category information DB 230 stores the unique key value information as well as the routing values of the DBs, so that it serves to provide the corresponding information (contents) to the smart device with reference to the unique key value information and the routing stored in the DB.

The click information and language obtaining unit 235 serves to obtain the unique key value information of the original (contents) and the unique key value information of the particular language clicked in the smart device.

The particular language translation information extraction unit 240 serves to extract the translation text information of the corresponding particular language from the text DB with reference to the unique key value information of the original (contents) and the unique key value information of the particular language obtained by the click information and language obtaining unit. Also, the particular language translation information text conversion unit 245 serves to convert the original text into the translation text information of the corresponding particular language extracted by the particular language translation information extraction unit, so that it is provided to the user.

Additionally, the multinational language conversion management server 200 further includes a member information obtaining unit 250 for obtaining a login information and an IP address information from the smart device; and a member region information DB 255 for storing a member region information and a using language information with reference to the information obtained by the member information obtaining unit.

The member information obtaining unit 250 serves to obtain the login information and the IP address information from the smart device. On the basis of this, the member region information DB 255 stores the member region information and the using language information.

Accordingly, the corresponding information (contents) is primarily outputted in the corresponding language of the logged-in member.

With the above construction, in order to provide the translation information (contents) in the particular language selected by the user, it is not necessary to reload the webpage.

In the change of the language, the language is not changed through the movement of the webpage. In other words, since the page loaded once can be utilized as it is, only the text portions of the information (contents) is transmitted in real time, thereby changing the language. Accordingly, it is not necessary to reload the unnecessary HTML tags and common parts of the web site (the images and videos, etc. such as a top menu, an advertisement, a bottom menu, and information (contents)), so that it can minimize the traffic.

Also, during the real-time transmission, the data transmission can be optimized by utilizing the AJAX, the XML, data compression techniques.

Additionally, the multinational language conversion management server 200 further includes a machine translation performing unit 260 for providing a machine-translated text information to the corresponding smart device by performing the machine translation thereof when the translation text information of the particular language is not existed therein.

For example, if the user wants to receive Korean translation thereof, it determines as to whether the translation text information of the contents is existed or not,

At this time, if it is not existed therein, the machine translation is performed through the translation performing unit and then, the corresponding text information is provided to the smart device.

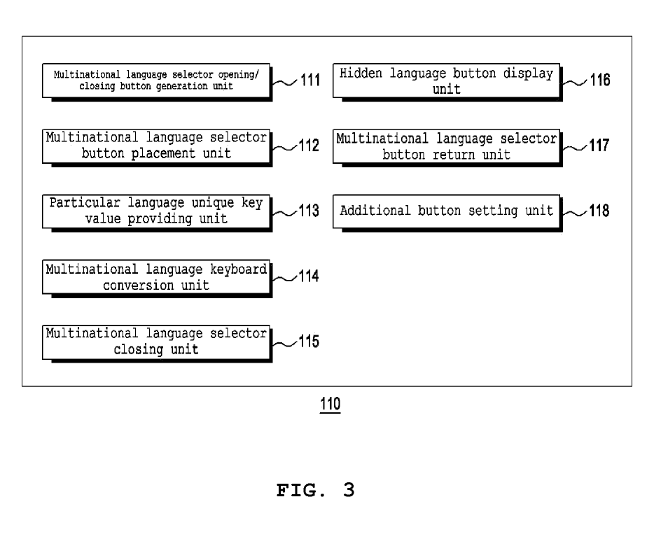

FIG. 3 is a block diagram illustrating a multinational language keyboard conversion means of a smart device capable of easily converting into multinational languages according to the present invention.

As described in FIG. 3, the multinational language keyboard conversion means 110 includes a multinational language selector opening/closing button generation unit 111 for generating a multinational language selector opening/closing button on the top of the keyboard; a multinational language selector button placement unit 112 for placing a multinational language selector button for language selection during event generation of clicking the multinational language selector opening/closing button; a particular language unique key value providing unit 113 for providing the unique key value of the corresponding language to a multinational language keyboard conversion unit when the particular language is clicked on the multinational language selector button; the multinational language keyboard conversion unit 114 for transmitting the provided unique key value of the corresponding language to the multinational language conversion management server 200 and relocating buttons of the keyboard provided by the multinational language conversion management server 200; and a multinational language selector closing unit 115 for closing the multinational language selector button when the relocation of the keyboard is completed.

As described above, when the smart device is provided with the multinational language keyboard conversion means 110, the multi-language conversion of the keyboard can be quickly and easily performed.

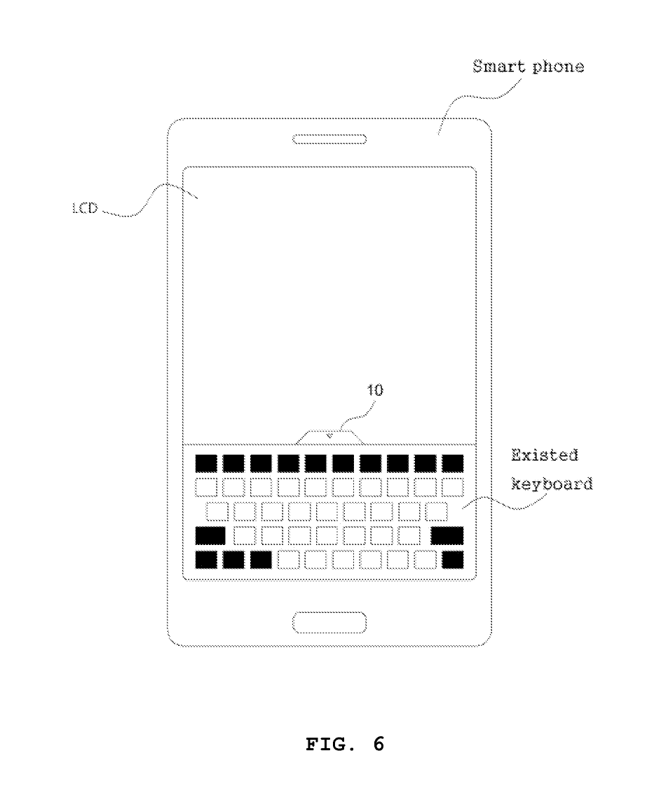

As shown in FIG. 6, the multinational language selector opening/closing button is placed on the top of the existed keyboard and the multinational language selector, which are the button set of the multinational language (code button of the corresponding language or icon representing the corresponding language), is appeared from bottom to top when the multinational language selector opening/closing button is clicked or slid from bottom to top.

If the multinational language selector opening/closing button is again clicked or slid from top to bottom, the multinational language selector is slid from top to bottom to be disappeared. After all, it returns to the initial state thereof.

More concretely, the multinational language selector opening/closing button generation unit 111 serves to generate the multinational language selector opening/closing button 10 on the top of the keyboard of the smart device.

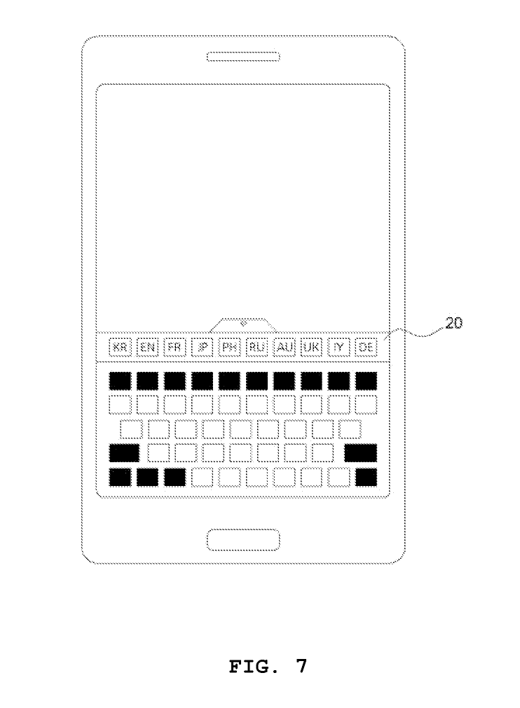

At this time, it waits for the click event of the multinational language selector button by means of the user. As shown in FIG. 7, the multinational language selector button placement unit 112 serves to place the multinational language selector button 20 for language selection during event generation of clicking the multinational language selector opening/closing button 10.

At this time, the particular language unique key value providing unit 113 serves to provide the unique key value of the corresponding language to the multinational language keyboard conversion unit when the particular language is clicked on the multinational language selector button 20.

The multinational language keyboard conversion unit 114 serves to transmit the provided unique key value of the corresponding language to the multinational language conversion management server 200 and relocate the buttons of the keyboard provided by the multinational language conversion management server 200.

For example, in the relocation of the keyboard, if the particular language is selected in English, the arrangement of the Korean keyboard is changed into the arrangement of the English keyboard.

Accordingly, the multinational language conversion management server 200 stores the button placement information of the keyboard by language and includes a keyboard button placement information DB (not shown).

The multinational language selector closing unit 115 serves to close the multinational language selector button when the relocation of the keyboard is completed.

In other words, the multinational language selector is slid from top to bottom to be disappeared. After all, only the multinational language selector opening/closing button is displayed thereon.

On the other hand, the multinational language keyboard conversion means 110 further includes a hidden language button display unit 116, a multinational language selector button return unit 117, and an additional button setting unit 118.

The hidden language button display unit 116 serves to allow the hidden language button to be additionally outputted to the screen by sliding the button set of the multinational language from left to right or from right to left when the multinational language selector button is opened.

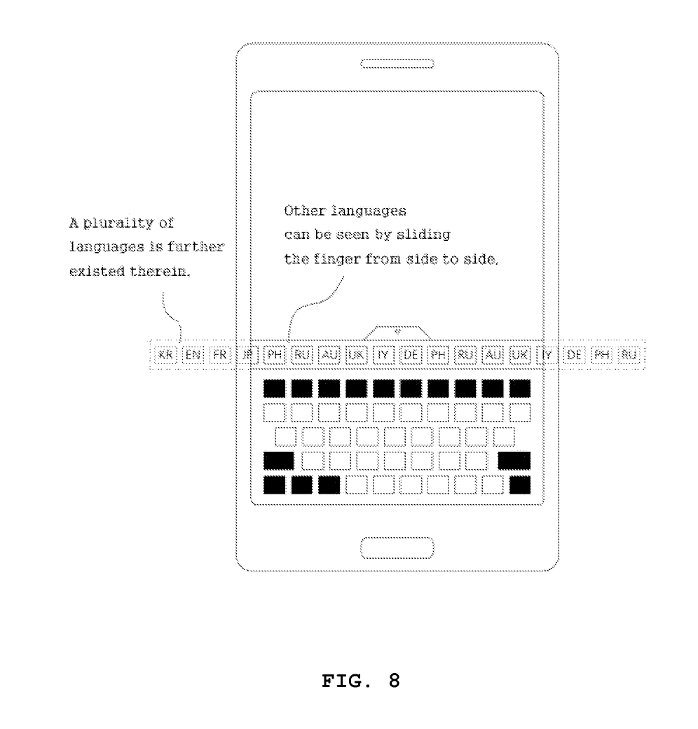

As shown in FIG. 8, it can provide the hidden language buttons.

The multinational language selector button return unit 117 serves to allow the multinational language selector button to be returned to the wait status by clicking the particular key among the keyboard buttons of the corresponding language, which is arranged through the click of the desiring language in the button set of the multinational language, when the multinational language selector button is opened.

In other words, the multinational language selector button is closed, on the contrary, only the multinational language selector opening/closing button is displayed thereon.

In the meantime, the additional button setting unit 118 serves to provide the setting button so as to set the language type of the keyboard.

That is, the setting button capable of selecting the using language is arranged as the first button among the multinational language selector button set, so that it can select and set the kind of the using language, the display method of the language, and the keyboard type (for example, Korea/2-set keyboard or 3-set keyboard) of the corresponding language by means of the click of the corresponding button.

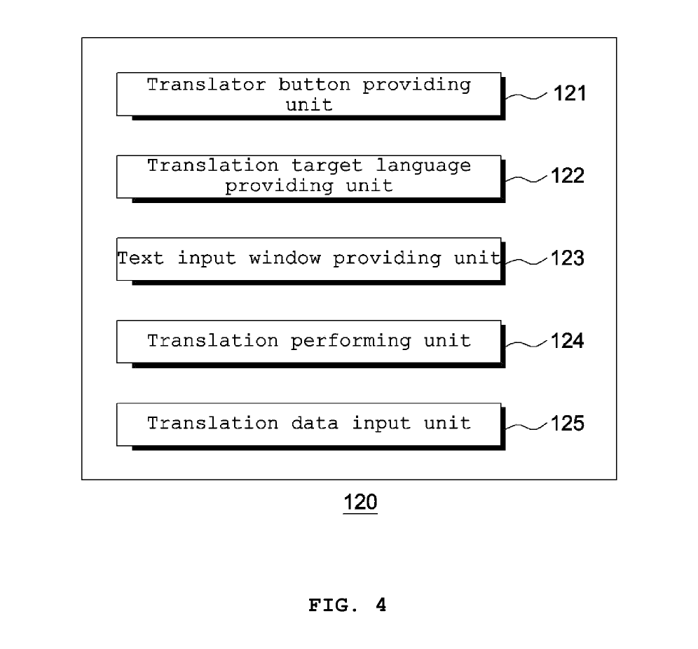

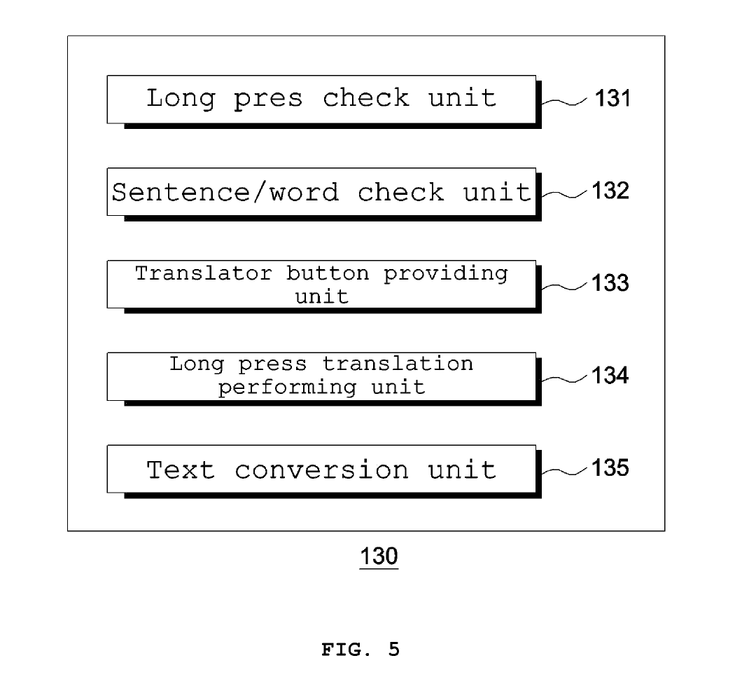

FIG. 4 is a block diagram illustrating a multinational language keyboard translation means of a smart device capable of easily converting into multinational languages according to the present invention.

As described in FIG. 4, the multinational language keyboard translation means 120 includes a translator button providing unit 121 for outputting a translator button to the screen; a translation target language providing unit 122 for outputting a translation target language button to the screen so as to select the translation target language during clicking of the translation button; a text input window providing unit 123 for providing a text input window; a translation performing unit 124 for obtaining the text information inputted to the text input window and performing the translation thereof with reference to the language translation DB of each nation; and a translation data input unit 125 for obtaining the translation information performed by the translation performing unit 124 and providing it to the translation information DB.

In other words, the translator button is located on any one area of the keyboard, so that a small translator is displayed on the top of the keyboard or in the form of a pop-up format without moving the webpage, thereby converting the text in his own language into the text in the third language.

In case of the method of using the translator, the application used is stopped and then, the translator application is driven to be translated. Thereafter, after it selects and copies the translated text and the translator application is stopped, it again returns to the existed application and then, pastes the translated text.

However, in the present invention, after the user clicks the translation button of the keyboard, the text is inputted and just translated. Finally, it clicks only the input button, thereby terminating all translation process.

Concretely, in case of the use procedure of the existed translator, it goes through a total of eight stages such as User application exit->Translator application execution->Text input->Translation->Selection and copy->Translator application exit->User application execution->Paste. However, in the present invention, it goes through a total of four stages such as Translation button click->Text input->Translation->Input.

More concretely, the translator button providing unit 121 serves to output the translator button to the screen. During the clicking of the translation button, the translation target language providing unit 122 serves to output the translation target language button to the screen so as to select the translation target language.

At this time, the text input window providing unit 123 serves to provide the text input window to the screen of the smart device. Then, the translation performing unit 124 serves to obtain the text information inputted to the text input window and perform the translation thereof with reference to the language translation DB (not shown) of each nation.

If the translation button is clicked in the contents area of the website, the text input window of the corresponding contents is provided and the translated data is stored in the translation information DB together with the unique key value information. After all, other users can utilize the translated data.

At this time, the translation data input unit 125 serves to obtain the translation information performed by the translation performing unit and provide it to the translation information DB to be stored.

FIG. 5 is a block diagram illustrating a long press translation means of a smart device capable of easily converting into multinational languages according to the present invention.

As described in FIG. 5, the long press translation means 130 includes a long press check unit 131 for checking out as to whether the text is pressed long or not; a sentence/word check unit 132 for checking out as to whether the text is a sentence or a word when the text is pressed long and providing the dictionary definition and the examples of the corresponding word where the text is the word; a translator button providing unit 133 for outputting the translator button to the screen and obtaining the selected language information; a long press translation performing unit 134 for obtaining the selected language information and translating the corresponding text with reference to the language translation DB of each nation; and a text conversion unit 135 for converting the corresponding text into the translated text.

In case of the long press translation, if the text is pressed long in the smart device such as smart phones, tablet PC, and so on, the long press translation means is provided through the pop-up such as copy, paste, and delete etc., and the translation language is selected through the click of the corresponding translation button, thereby translating the text into the selected language. The corresponding method can be used in smart devices in general.

For example, the sending text is inputted in the smart phone or the tablet PC during the sending of the text and then, the inputted text is pressed long, so that the translation button and the pop-up such as copy, paste, and delete etc., are displayed thereon. At this time, if the translate button is clicked, the small window capable of selecting the languages is opened. Then, if the desiring language is selected, the existed text is replaced with the translated text.

As another example, when the user does not know the language on a quest of the websites in the smart device, the text of the corresponding language is pressed long, so that the translation button and the pop-up such as copy, paste, and delete etc., are displayed thereon. At this time, if the translate button is clicked, the small window capable of selecting the languages is opened. Then, if the desiring language is selected, the original text of the corresponding website is replaced with the translated text.

As further another example, the long press translation method can be utilized in a word unit, depending on the range of choices. That is, the full sentence selected through the long pressing is narrowed in a word unit and then, it clicks the translation button. In this case, the dictionary definition and the examples etc. of the corresponding word are displayed on the small pop-up.

More concretely, the long press check unit 131 serves to check out as to whether the text is pressed long in the smart device or not.

For example, the long press check unit 131 checks out as to whether the text is pressed for few seconds every each smart device or not. This technique is widely well-known.

The sentence/word check unit 132 serves to check out as to whether the text is a sentence or a word when the text is pressed long and provide the dictionary definition and the examples of the corresponding word where the text is the word.

In other words, if the text is the sentence, it selects the translating language. However, in case of the word, after it selects the translating language, the dictionary definition and the examples of the corresponding word can be provided.

At this time, the translator button providing unit 133 serves to output the translator button to the screen and obtain the selected language information.

The long press translation performing unit 134 serves to obtain the selected language information and translate the corresponding text with reference to the language translation DB of each nation. Also, the text conversion unit 135 serves to convert the corresponding text into the translated text.

After all, there is an effect in that it connects to a website for providing multinational language information (contents) by using a user terminal; transmits unique key value information of particular original information (contents) and unique key value information of specific language to a multinational language conversion management server when it clicks the particular original information (contents) and the desiring specific language; providing the contents information converted into the specific language; transmits unique key value of specific language to the multinational language conversion management server when it selects the specific language from a multinational language selector button arranged on a keyboard of the smart device; and relocates the keyboard button provided from the multinational language conversion management server, thereby rapidly and easily processing the multinational language conversion and easily converting into the multinational languages using the keyboard button of the smart device

Although a preferred embodiment of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention can be widely applied to an industrial field of the smart device capable of easily converting into multinational languages.

What is claimed is:

1. A smart device capable of easily converting into multinational languages comprising:
a smart device 100 for connecting to a website for providing multinational language information (contents), transmitting unique key value information of particular original information (contents) and unique key value information of specific language to a multinational language conversion management server when it clicks the particular original information (contents) and the desiring specific language, transmitting unique key value of specific language to the multinational language conversion management server when it selects the specific language from a multinational language selector button arranged on an upper end of a keyboard, and relocating the keyboard button provided from the multinational language conversion management server; and
the multinational language conversion management server 200 comprising an original information DB 205 for storing at least one information among a text information, an image information, a video information, and an audio information of the original (contents) and storing the unique key value information of the original (contents); a translation information DB 210 for storing a translation text information by language of matching with the unique key value information of the original (contents); an unique key value information DB by information 215 for storing and managing the unique key value information of the original (contents) and an unique key value information by language; a text DB 220 for matching the original text and the translation text information with the unique key value information of the original (contents) and the unique key value information by language to be stored; a multimedia information DB 225 for storing at least one information among the image information, the video information, and the audio information attached to the information (contents) of matching with the unique key value information of the original; a category information DB 230 for storing the unique key value information of the original (contents) and the unique key value information by language stored in the unique key value information DB by information and routing values of the DBs; a click information and language obtaining unit 235 for obtaining the unique key value information of the original (contents) and the unique key value information of the particular language clicked in the smart device; a particular language translation information extraction unit 240 for extracting a translation text information of the corresponding particular language from the text DB with reference to the unique key value information of the original (contents) and the unique key value information of the particular language obtained by the click information and language obtaining unit; and a particular language translation information text conversion unit 245 for converting the original text into the translation text information of the corresponding particular language extracted by the particular language translation information extraction unit.

2. A smart device capable of easily converting into multinational languages as claimed in claim 1, wherein the multinational language conversion management server 200 further comprises:
a member information obtaining unit 250 for obtaining a login information and an IP address information from the smart device;
a member region information DB 255 for storing a member region information and a using language information with reference to the information obtained by the member information obtaining unit; and
a machine translation performing unit 260 for providing a machine-translated text information to the corresponding smart device by performing the machine translation thereof when the translation text information of the particular language is not existed therein.

3. A smart device capable of easily converting into multinational languages having a smart device 100 and a multinational language keyboard conversion means 110, the smart device 100 comprising:
a multinational language selector opening/closing button generation unit 111 for generating a multinational language selector opening/closing button on the top of the keyboard;
a multinational language selector button placement unit 112 for placing a multinational language selector button for language selection during event generation of clicking the multinational language selector opening/closing button;
a particular language unique key value providing unit 113 for providing the unique key value of the corresponding language to a multinational language keyboard conversion unit when the particular language is clicked on the multinational language selector button;
a multinational language keyboard conversion unit 114 for transmitting the provided unique key value of the corresponding language to the multinational language conversion management server and relocating buttons of the keyboard provided by the multinational language conversion management server; and
a multinational language selector closing unit 115 for closing the multinational language selector button when the relocation of the keyboard is completed; and
the multinational language keyboard conversion means 110 comprising:
a hidden language button display unit 116 for allowing a hidden language button to be additionally outputted to the screen by sliding the button set of the multinational language from left to right or from right to left when the multinational language selector button is opened;
a multinational language selector button return unit 117 for allowing the multinational language selector button to be returned to the wait status by clicking the particular key among the keyboard buttons of the corresponding language, which is arranged through the click of the desiring language in the button set of the multinational language, when the multinational language selector button is opened; and
an additional button setting unit 118 for providing the setting button so as to set the language type of the keyboard.

4. A smart device capable of easily converting into multinational languages as claimed in claim 1, wherein the smart device 100 comprises a multinational language keyboard translation means 120 and the multinational language keyboard translation means 120 comprises:
a translator button providing unit 121 for outputting a translator button to the screen;
a translation target language providing unit 122 for outputting a translation target language button to the screen so as to select the translation target language during clicking of the translation button;
a text input window providing unit 123 for providing a text input window;
a translation performing unit 124 for obtaining the text information inputted to the text input window and performing the translation thereof with reference to the language translation DB of each nation; and
a translation data input unit 125 for obtaining the translation information performed by the translation performing unit 124 and providing it to the translation information DB.

5. A smart device capable of easily converting into multinational languages having the smart device 100 and a long press translation means 130, the long press translation means 130 comprising:
a long press check unit 131 for checking out as to whether the text is pressed long or not;
a sentence/word check unit 132 for checking out as to whether the text is a sentence or a word when the text is pressed long and providing the dictionary definition and the examples of the corresponding word where the text is the word;
a translator button providing unit 133 for outputting the translator button to the screen and obtaining the selected language information;
a long press translation performing unit 134 for obtaining the selected language information and translating the corresponding text with reference to the language translation DB of each nation; and
a text conversion unit 135 for converting the corresponding text into the translated text.

6. A smart device capable of easily converting into multinational languages having a multinational language keyboard conversion means 110, the multinational language keyboard conversion means comprises:
a multinational language selector opening/closing button generation unit 111 for generating a multinational language selector opening/closing button on the top of the keyboard;
a multinational language selector button placement unit 112 for placing a multinational language selector button for language selection during event generation of clicking the multinational language selector opening/closing button;
a particular language unique key value providing unit 113 for providing the unique key value of the corresponding language to a multinational language keyboard conversion unit when the particular language is clicked on the multinational language selector button;
the multinational language keyboard conversion unit 114 for transmitting the provided unique key value of the corresponding language to the multinational language conversion management server 200 and relocating buttons of the keyboard provided by the multinational language conversion management server; and
a multinational language selector closing unit 115 for closing the multinational language selector button when the relocation of the keyboard is completed.
